(19) United States
(12) Patent Application Publication
(10) Pub. No.: US 2006/0032289 A1
(43) Pub. Date: Feb. 16, 2006

(54) Non-optical explosive sensor based on two-track piezoresistive microcantilever

(76) Inventors: Lal Ariyaratna Pinnaduwage, Knoxville, TN (US); Dechang Yi, Oak Ridge, TN (US); Thomas George Thundat, Knoxville, TN (US); John Eric Hawk, Germantown, TN (US)

Correspondence Address: UT-Battelle, LLC;Office of Intellectual Property, One Bethal Valley Road, 4500N, MS-6258, Oak Ridge, TN, 37831, US

(21) Appl. No.: 11/052,556

(22) Filed: Feb. 7, 2005

Related U.S. Application Data
(60) Provisional application No. 60/600,760, filed on Aug. 11, 2004.

(51) Int. Cl. G01N 27/14

(52) U.S. Cl. 73/25.05; 73/31.02

(57) ABSTRACT

A two-track piezoresistive cantilever detects explosives in ambient air by measuring resistance changes in the cantilever when one piezoresistive track is pulse heated to cause deflagration of explosive adhered to the surface of the cantilever. The resistance measurement is through the second piezoresistive track, which is located at the most resistance-sensitive area. The resistance change of this track is caused by the temperature change of the cantilever as well as the bending of the cantilever due to bi-material thermal expansion. The detecting method using this novel cantilever avoids the use of any optical components such as a laser and position sensing detector (PSD), which are necessary in traditional detecting systems using cantilevers. Therefore, it can extremely reduce the complexity of the detecting system and make a portable chemical detection system possible that is small, less expensive, and able to be mass produced and is particularly useful for the detection of explosives.

### CROSS-REFERENCE TO RELATED APPLICATIONS

This application claims priority to U.S. Provisional Patent Application 60/600,760 filed Aug. 11, 2004, and is herein incorporated by reference.

### STATEMENT REGARDING FEDERALLY SPONSORED RESEARCH

This invention was made with United States Government support under Contract No. DE-AC05-00OR22725 between the United States Department of Energy and U.T. Battelle, LLC. The United States Government has certain rights in this invention.

### FIELD OF THE INVENTION

This invention relates to portable detectors that can be particularly useful in the identification of small amounts of powerful explosives commonly used in “plastic explosives,” particularly favored by terrorist organizations, as well as other explosives capable of deflagration caused by heat. The novel, portable system is especially rugged and useful for the detection of any chemical that exhibits a rapid exothermic or endothermic response to a heated surface.

### BACKGROUND OF THE INVENTION

Cantilevers such as microcantilevers have become established as useful experimental devices for the detection of very small samples of a variety of analytes. Remarkable flexibility is obtained using optical detection of small movements of the cantilevers based on changes in vibrational frequency or surface energy changes. Representative of the sophistication of this detection method is U.S. Pat. No. 6,763,705, to Thundat et al., herein incorporated by reference, which provides the advantage of high output for hybridization reactions; and U.S. Pat. No. 5,918,263, herein incorporated by reference, to Thundat, that teaches an optical readout device for explosives detection.

The universal application of this technology has been limited by the use of optics for detection, meaning that the systems are adapted for laboratory use not used in the field. However, it is the detection of chemical and biological agents outside a laboratory setting that has taken on added urgency as the result of the activities of terrorists. The current invention allows the development of a simple compact sensor that does not need optics.

Of the common explosives that have been used in terrorist bombings, high explosives such as pentaerythritol tetranitrate (PETN) and hexahydro-1,3,5-triazine (RDX)—frequently used with plastic filler—are the most serious threats in aircraft sabotage because they can be easily molded for concealment, are very stable in the absence of a detonator, and in small amounts are able to destroy a large airplane in flight, a car, bus, passenger train car or a boat. They are, in fact, the explosives most commonly used for this purpose. The vapor pressures of PETN and RDX are quite low, in the range of parts per trillion (PPT) at ambient temperatures.

The more recent and refined detection techniques are ion mobility spectroscopy (IMS), negative-ion atmospheric pressure chemical ionization mass spectrometry (APCI-MS) and laser-induced fluorescence. The most sensitive method reported thus far seems to be IMS, for which limits of detection (LOD) of 80 pg and 300 pg for PETN and RDX, respectively, have been reported. However, the sampling in the reported testing was not in the form of the vapor phase, and the explosive material was introduced by the injection of prepared solutions.

The effort and technology involved in the detection of explosives are orders of magnitude more expensive than the effort and costs incurred by terrorists in deploying them. The sensors in current use are bulky and expensive and cannot be miniaturized. Only with the development of extremely sensitive and inexpensive sensors that can be mass-produced can sensors be deployed in large enough numbers so that the cost of detection by law enforcement will be less than the cost of deployment by terrorists. Micro-electro-mechanical systems (MEMS) with sufficient detection capability are good candidates for such miniature detectors. We are aware of only four studies, herein incorporated by reference, using MEMS to detect vapors from explosives, all four studies by us using microcantilevers: (i) detection of plastic explosive vapors using self-assembled monolayer coated microcantilevers (L. A. Pinnaduwage, V. Boiadjiev, J. E. Hawk, and T. Thundat, “Sensitive Detection of Plastic Explosives with Self-Assembled Monolayer-Coated Microcantilevers”, Appl. Phys. Lett., 83 (7), 1471-1473 (2003), (ii) our studies with polymer-coated cantilevers, which yielded detection levels of 100 ppt for DNT; L. A. Pinnaduwage, T. Thundat, J. E. Hawk, D. L. Hedden, P. F. Britt, E. J. Houser, D. Bubb, S. Stepnowski, and R. A. McGill, “Detection of 2,4 Dinitrotoluene Using Microcantilever Sensors”, Sensors and Actuators B 99, 223 (2004), and our studies on the detection of TNT using uncoated microcantilevers: (iii) L. A. Pinnaduwage, Gehl, D. L. Hedden, G. Muralidharan, T. Thundat, R. T. Lareau, 61. T. Sulchek, L. Manning, B. Rogers, M. Jones, J. D. Adams, “A Microsensor for Trinitrotoluene Vapour,” Nature 425, 474 (2003), and (iv) L. A. Pinnaduwage, A. Wig, D. Hedden, A. Gehl, D. Yi, T. Thundat, and R. T. Lareau, “Detection of Trinitrotoluene via Deflagration on a Microcantilever”, Journal of Applied Physics 95, 5871 (2004).

For generic explosives, the knowledge that an explosive is present may be all that is necessary for mass screening such as at airports, train stations and docks. Land and personnel mines are a persistent threat in many countries and a simple means for their detection is not available. There abides a need for a simple, rugged, reliable sensor and screening instrument for the detection of common explosives.

### BRIEF DESCRIPTION OF THE INVENTION

Most work in this field has been done using optical detection of cantilever bending, a highly accurate method which is not especially rugged. Such systems can yield valuable information in the laboratory and other highly controlled settings, but are not sufficiently portable and rugged to be used on passengers, luggage compartments or shipping containers.

We have found that comparable sensitivity can be obtained using piezoelectric and piezoresistive self-sensing and self-actuating cantilevers which are more compact and more rugged than optical sensing methods and more suitable for field use. The system is especially useful for the detection of common explosives such as trinitrotoluene (TNT), pentaerythritol tetranitrate (PETN), nitroglycerin and hexahydro-1,3,5-triazine (RDX).

The first aspect of this invention is based upon the use of an uncoated cantilever which has been fabricated to have two piezoresistive tracks. The first track is substantially the same as that found in commercial piezoresistive cantilevers. The second track, preferably around the perimeter of the cantilevers, serves as a resistive heater. When the deflagration event is triggered by heating of the cantilever using the second piezoresistive track, the event is detected using the first piezoresistive track. Such a device is sturdy, self-cleaning, immediately re-useable and small enough to be used as a hand-held device and, in one embodiment, also can detect mass loading.

Uncoated cantilevers respond to a limited number of analytes but are suitable for a number of analytes which have low vapor pressure but are of critical interest; RDX, PETN, TNT and nitroglycerine being among them. The two track cantilever detects both exothermic and endothermic response on the heated surface. Exothermic reactions—those associated with explosives—lead to the release of energy to the cantilever thus resulting in “an additional bending” of the cantilever. Endothermic reactions—those associated with non-explosives-remove heat from the cantilever thus leading to the bending of the cantilever in the opposite direction to that associated with an exothermic reaction. Both exothermic and endothermic responses result in almost instantaneous removal of the analyte from the surface of the cantilever. The cantilever responds by returning to a neutral “unloaded” position.

Cantilevers with reduced dimensions are called nanocantilevers. Nanocantilevers typically have a length of approximately 1 μm (micron). The thickness and width of a nanocantilever are adjusted such that the cantilever is free from size-induced deformations. When the term cantilever is used in this disclosure, both microcantilevers and nanocantilevers are meant. Furthermore, even “macrocantilevers” of area up to several square centimeters could be used as well, as long as the spring constant is kept in the range of roughly about 0.05 N/m to 0.5 N/m.

### BRIEF DESCRIPTION OF THE DRAWINGS

FIG. 1 is a schematic diagram of a prior art detection method for explosives.

FIG. 2 is a schematic diagram of a two-track cantilever according to this invention.

FIG. 3 is a schematic diagram of the electronic circuit of this invention.

FIG. 4 is a plot sensor output vs. time during a detection cycle.

### DETAILED DESCRIPTION OF THE INVENTION

We have developed a method for identifying explosives such as TNT, PETN, nitroglycerin and RDX which is portable (hand held) and self-contained using a proprietary probe and a personal computer or personal assistant (PDA).

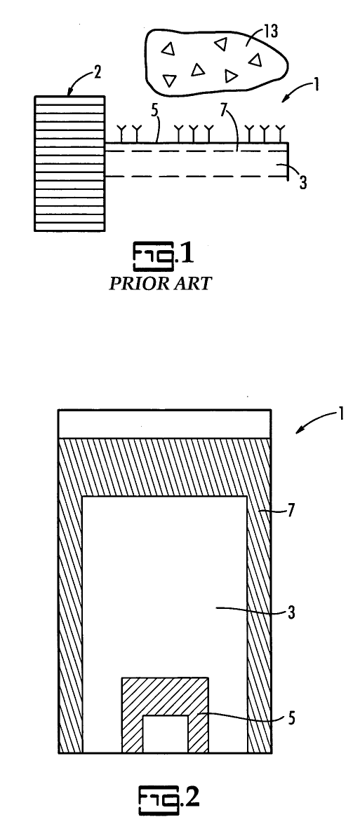

The inventors previously reported that PETN and RDX could be detected using coated cantilevers heated by a piezoresistive track and detected optically using a laser diode and a photodetector. FIG. 1 from U.S. Pat. No. 5,918,263 illustrates the system. Such a system requires coating the cantilever and the optical detection system is more suitable for a laboratory than for use in the field searching luggage in airports and for land mines in former battlefield areas. The inventors have reported that molecular loading and deflagration on a heated, uncoated cantilever can be detected using the optical detection system. [Pinnaduwage et al., Nature (London) 425, 474 (2003); herein incorporated by reference] and, [Pinnaduwage et al., J. Appl. Phys., 95, 5871; herein incorporated by reference]. The cantilever had a single piezoresistive track which was used for heating only.

It now has been discovered that the optical detector can be deleted, installation and maintenance simplified, and ruggedness and reliability improved by use of a novel cantilever having two tracks; one for heating and one for detection.

FIG. 2 shows a schematic diagram of the two-track piezoresistive cantilever according to the invention. The cantilever 1 has a first major surface 3 and a second major surface (not shown). A first piezoresistive track 5 detects movement in the cantilever. A second piezoresistive track 7 disposed substantially around the periphery of the cantilever serves as the heating element.

Cantilevers are typically formed from silicon or silicon nitride. The most commonly used dopant to form the piezoresistive channel is boron. Other dopants, both p- and n-type, may be employed. The width of the channel is approximately 4 micrometers and the resistance approximately 2 to 2.5 kohms. This allows the cantilever to be heated to approximately 500° C., using a 10 V, 10 ms voltage pulse (corresponding to a current of ca. 5 mA).

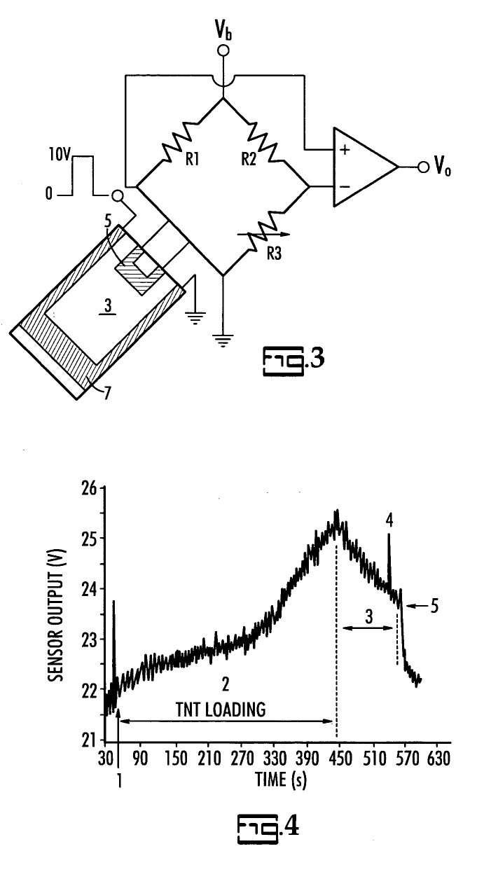

FIG. 3 is a schematic of the measurement scheme with a two-track piezoresistive microcantilever. A voltage pulse is applied to the outer track 7 to heat the microcantilever and thereby to deflagrate the deposited explosive material. The first track 5 is connected to a Wheatstone bridge circuit so that the change in resistance can be monitored simultaneously with the application of the voltage pulse to the outer track 7.

When the reaction of the analyte is an exothermic event, the microcantilever senses the change of its resistance due to two factors; 1) temperature change arising from the heat generated by the deflagration event; and 2) change in cantilever bending arising from the heat generated. In the first case, the heat released by the deflagration event of the explosives increases the cantilever temperature. Since the resistance of the cantilever is related with its temperature, the heat from the deflagration even will cause the change of cantilever resistance. Also, the temperature change results in the bending of the cantilever, presumably due to the bi-material thermal expansion. Therefore, the resistance of the cantilever changes more due to the piezoresistive effect.

Mass loading can be determined by monitoring the resonance frequency of the cantilever before and after exposure to the explosive vapor. This is accomplished by driving the cantilever with a signal of constant amplitude but variable frequency in the region of the resonance frequency of the cantilever. The bending signal is maximized when the driving signal approaches the resonance frequency of the cantilever.

Referring to FIG. 4, a five-event TNT detection test is graphically presented using the self-sensing platform illustrated in FIG. 1. During event 1, before loading with TNT a reference voltage pulse (25 volts) is applied to the piezoresistive heater causing a temporary upward spike in circuit output that is due to heating. TNT loading (event 2) causes a gradual upward shift in sensor output which then gradually decreases when the TNT begins to desorb from the cantilever (event 3). The second pulse (5 volts) during desorption does not raise the cantilever temperature sufficiently for deflagration (event 4). The third pulse (25 volts) causes deflagration as shown by a visible smoke plume, and a dramatic mass decrease, which is verified by a reduction in circuit output (event 5) that overwhelms the upward thermal signal evident in event 1. Post-deflagration reference pulses of 25 volts resulted in spikes similar to the one seen in event 1.

The occurrence of deflagration was inferred from three consistent observations. First, the cantilever returns to its pre-test resonance frequency after deflagration, suggesting that all of the adsorbed material has been lost. Second, a specific voltage (corresponding to a threshold or deflagration point temperature) is necessary to cause deflagration. Third, the measurement of heat added to the cantilever during deflagration shows that the reaction is exothermic ruling out other possible reactions such as melting, vaporization or decomposition.

Our method currently detects the deflagration of approximately 70 picograms (1.9×10¹¹ molecules) or less of TNT (calculated from the shift in cantilever resonance). This limit of detection is the same as that of an improved version of the ion-mobility mass-spectrometry technology now used for airport security. Calculations show that the detection limit could be improved by up to three orders of magnitude by using optimized cantilevers.

### INDUSTRIAL UTILITY

The detection system and device of this invention is useful in the inspection of facilities in which valuable property may be kept on in which people may assemble. Particular value is seen in the mass transportation industry due to specificity, ease of use and portability.

The sensor device of the invention can be used by security personnel to screen for plastic explosives in all transportation facilities.

The invention has been described in terms of specific embodiments which are indicative of a broad utility but are not limitations to the scope of the invention. Additions and modifications apparent to those with skill in the art are included within the scope and spirit of the invention.

We claim:

1. A cantilever detector for airborne chemicals comprising:
a) at least one uncoated cantilever having at least two separate piezoresistive tracks;
b) means to pulse heat into at least one piezoresistive track;
c) means to detect resistive changes in at least one piezoresistive track; and
d) means to display sensed changes in resistance of at least one piezoresistive track.

2. A cantilever detector according to claim 1 wherein the airborne chemical detected is one which undergoes an exothermic reaction on heating.

3. A cantilever detector according to claim 2 wherein the airborne chemical is an explosive.

4. A cantilever detector according to claim 3 wherein said explosive is selected from the group consisting of trinitrotoluene, pentaerythritol tetranitrate, nitroglycerine and hexahydro-1,3,5-triazine.

5. A cantilever detector according to claim 4 wherein said means to detect further comprises a detection limit of approximately 70 picograms or less of trinitrotoluene.

6. A cantilever detector according to claim 1 wherein the airborne chemical detected is one which undergoes an endothermic reaction when heated.

7. A cantilever detector according to claim 1 wherein one of said piezoresistive tracks is disposed substantially at the periphery of said cantilever.

8. A cantilever detector according to claim 7 wherein said piezoresistive track disposed substantially at the periphery is pulse heated.

9. A method for detecting an airborne chemical in ambient air comprising:
providing an uncoated cantilever having two piezoresistive tracks disposed therein;
pulsing a current through one of said piezoresistive tracks to heat said cantilever;
detecting the deflection of said cantilever by monitoring the resistive change in the unpulsed piezoresistive track.

10. A method according to claim 9 wherein the airborne chemical detected is one which undergoes an exothermic reaction on heating.

11. A method according to claim 10 wherein the airborne chemical is an explosive.

12. A method according to claim 11 wherein said explosive is selected from the group consisting of trinitrotoluene, pentaerythritol tetranitrate, nitroglycerine and hexahydro-1,3,5-triazine.

13. A method according to claim 12 wherein said detecting step further comprises a detection limit of approximately 70 picograms or less of trinitrotoluene.

14. A method according to claim 9 wherein the airborne chemical detected is one which undergoes an endothermic reaction when heated.

15. A method according to claim 9 wherein one of said piezoresistive tracks is disposed substantially at the periphery of said cantilever.

16. A method according to claim 15 wherein said piezoresistive track disposed substantially at the periphery is pulse heated.
